(19) United States
(12) Patent Application Publication
(10) Pub. No.: US 2002/0076254 A1
(43) Pub. Date: Jun. 20, 2002

(54) Doublet applicator device

(76) Inventors: John Calabro, Buffalo, NY (US); Thomas O'Shei, West Seneca, NY (US)

Correspondence Address: ARTHUR S. COOKFAIR, 201 GLENALBY ROAD, TONAWANDA, NY, 14150, US

(21) Appl. No.: 09/998,608

(22) Filed: Nov. 30, 2001

Related U.S. Application Data
(60) Provisional application No. 60/250,671, filed on Dec. 1, 2000.

(51) Int. Cl. A47L 13/12; B05C 1/00

(52) U.S. Cl. 401/23; 401/17; 401/35

(57) ABSTRACT

A doublet liquid applicator device comprises two singlet liquid applicator devices held together in a side by side relationship along matching sidewalls by an outer shrink-wrap film. Each singlet liquid applicator device comprises a liquid applicator at the top end and a housing enclosing a liquid reservoir in fluid communication with the liquid applicator. The doublet device may be filled with two differently colored inks to provide a bingo marker or the like suitable for applying either of two different marking colors

This application claims the benefit of Provisional Application No. 60/250,671, filed Dec. 1, 2000.

### BACKGROUND OF THE INVENTION

1. Field of the Invention

This invention relates to devices for applying liquids or other materials as marks or coatings to surfaces and in particular to hand held marking devices for applying ink on a surface.

2. Background and Prior Art

Hand held applicator devices, such as marking devices, are commonly used to apply liquids, such as ink, to surfaces, such as paper, cardboard or other, for purposes including record keeping, labeling, highlighting or other. In many instances it is helpful for the user to have easy access to more than one marking or coating medium. Thus, for example, in the highlighting of a document, it is often convenient to employ two different colors to call attention to, or highlight different aspects of the document. Furthermore, the increasing popularity of games, such as Bingo, has brought with it an increasing use of highlighting markers.

In the game of bingo, each player has a bingo card having printed thereon a number of squares arranged in rows and columns. Typically there are five columns each identified at the top by a letter. Each square is identified by a number. During the game, as a game master calls a number and the column in which it may be found, a player whose card matches the call, records it on the appropriate square. Traditionally, the recording of a particular call was accomplished by covering the corresponding square with a small plastic or paper disc. In recent years, it has become common practice to identify a number called by marking the corresponding square with an ink-marking device. Many players play more than one game at the same time, using different cards, and different marking colors, for each game being played. Some players use two or more differently colored markers. However, in a fast-paced game it may be time-consuming and confusing to put down one marking device and find a differently colored marking device, make the mark and be ready for the next call. There is a need for a hand-held liquid applicator device that may be conveniently used to apply two or more liquids, especially two or more differently colored inks, from the same device. Various devices for use as bingo markers and other uses are known. Some of the known devices are designed to allow the application of two differently colored inks from separate reservoirs in the same device. Thus, for example, U.S. Pat. No. 5,899,619 to O'Shei discloses a hand held marking device including two separate depositing means and two independent refillable fluid reservoirs for holding liquids to be applied. The device additionally includes a bumper extending from the top portion to prevent both depositing means from simultaneously contacting the surface to be marked. Such devices are typically made of plastic and are produced, for example, by blow molding or injection molding. However, the manufacture of a unit of this type, having two separate reservoirs involves some difficulty.

U.S. Pat. No. 4,863,171 to Rocheleau discloses a dabber for marking items such as bingo cards, the dabber being in the general shape of a hammer with the head provided with two oppositely directed ink applicators.

U.S. Pat. No. 5,713,681 to Venne et al. discloses a bingo card ink marker bottle ergonomically designed for ease of holding during use. The bottle is of molded plastic and comprises an ink reservoir with an ink applicator mounted on the neck of the bottle.

U.S. Pat. No. 5,904,430 to Alessi, discloses a hand held marking device which can be used to apply at least two different colored inks, and which has at least two independent refillable ink reservoirs. The device is detachable into independent markers and re-attachable to form a double depositing marking device.

### SUMMARY OF THE INVENTION

It is an object of the present invention to provide an applicator device suitable for manually applying to a surface, either of two different coating materials.

It is a further object to provide a method for making such a device.

It is a further object of the present invention to provide a hand held marking device suitable for the convenient application of at least two different colored inks and having at least two independent refillable ink reservoirs.

It is an additional object to provide a hand held bingo marking device having at least two applicators for applying differently colored inks.

It is a still further object to provide a hand held doublet marking device having two independent refillable liquid reservoirs and a method for the manufacture thereof.

The above and other objects are achieved in accordance with the present invention which provides a doublet applicator device suitable for manually applying at least two different liquids, the device comprising two similarly shaped singlet applicator devices held together along matching or mating wall portions thereof, each singlet applicator device comprising a housing having an elongated surrounding wall having a mating portion, a top end, and a bottom end, enclosing a liquid reservoir in fluid communication with a liquid dispenser at the top end. Preferably, the liquid dispenser at the top end is a dauber of compressible open celled plastic foam or other material capable of absorbing a fluid and releasing it when pressed against a surface. If more viscous fluids are to be dispensed, the dauber may be omitted and the opening at the top end of the singlet may be adapted to accommodate the more viscous liquid. Thus for example, the doublet devices of the present invention may be adapted to dispense, for example, shampoo from one side and a conditioner from the other, or a choice of condiments, such as ketchup from one side and mustard from the other. In another embodiment, the liquid applicator at the top end may be replaced with a perforated cap suitable for the dispensing of either of two different powdered or granulated materials, to provide, for example, a salt and pepper shaker.

Each of the singlet applicator devices is shaped with a matching or mating surface along one side of the elongated surrounding wall that allows the two singlet applicator devices to be joined along their matching surfaces to form a doublet liquid applicator device. Preferably the matching surfaces are flat. However, other shaped surfaces may be employed provided they conformably fit, or nest, together to form a doublet. Thus, for example, one singlet may have a concave surface that conforms to a convex surface of a second singlet. The two singlet liquid applicator devices may be joined along their matching surfaces in various ways, such as gluing, cementing, sonic welding, or the like. In a preferred embodiment, the two singlets are joined by aligning their matching surfaces and wrapping a shrink-wrap plastic film around the matched pair and heat-shrinking the film. The use of shrink-wrap plastic film for this purpose offers an additional advantage in that a decoration, label, logo, or other informational or decorative image to be applied to the doublet device may be conveniently printed on the plastic film.

The doublet applicator device of the present invention, having daubers at the top end oriented in opposing directions as shown in the accompanying drawings are particularly useful as highlighters or as marking devices for bingo games.

In another aspect, the present invention relates to a method for manufacturing a doublet liquid applicator device which comprises providing two singlet liquid applicator devices, as described hereinabove, and joining them together along mating surfaces, preferably with an outer surrounding shrink-wrap plastic film.

The singlet liquid applicator devices may be formed by blow molding or injection molding using plastic or resin materials. Such processes and suitable materials therefore are well known.

Various liquids may be held and applied with the applicator of the present invention, including for example, inks, solvents, lubricants, paints, glues, and the like.

The method of the present invention may be used to form doublet devices suitable for the various materials other than liquid marking materials. Thus for example, the hereinabove mentioned

### BRIEF DESCRIPTION OF THE DRAWINGS

The present invention and the manner in which it may be practiced is further illustrated with reference to the accompanying drawings wherein:

FIG. 1 is a elevational perspective view of an embodiment of the doublet liquid applicator device of the present invention;

FIG. 2 is a bottom plan view of the embodiment of FIG. 1;

FIGS. 3a and 3b show an elevational view of two matched singlet liquid applicator devices that may be joined together to form a doublet liquid applicator device as depicted in FIG. 1;

FIG. 4 depicts a cutaway view of an embodiment of the present invention corresponding to FIG. 1.

FIG. 5 shows an elevational view of an alternate embodiment of a doublet liquid applicator in accordance with the present invention.

FIGS. 6a and 6b show an elevational view of two matched singlet liquid applicator devices (with screw caps removed) that may be joined together to form a doublet liquid applicator device as depicted in FIG. 5;

FIG. 7 shows a bottom perspective view of the embodiment of FIG. 5.

### DETAILED DESCRIPTION OF THE DRAWINGS

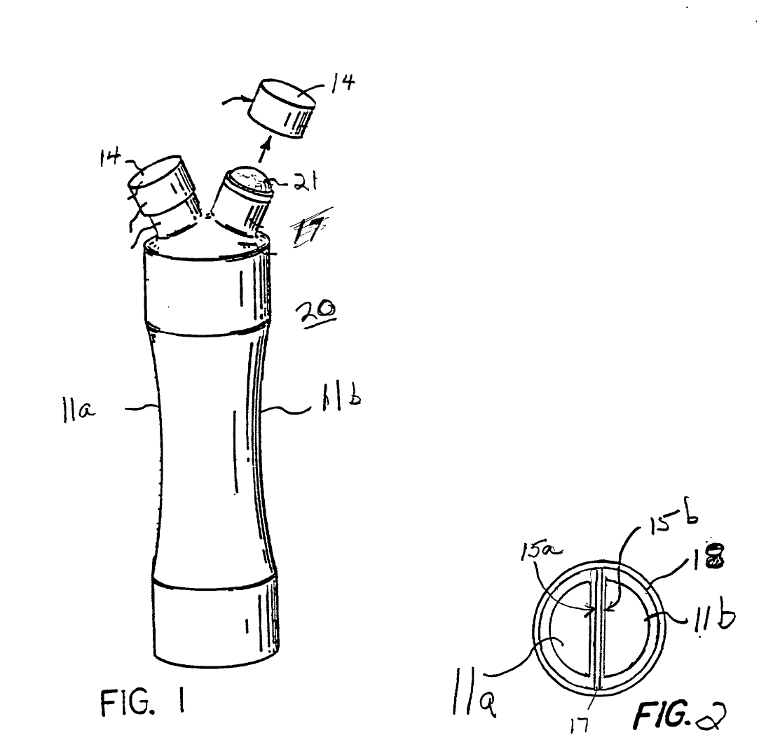

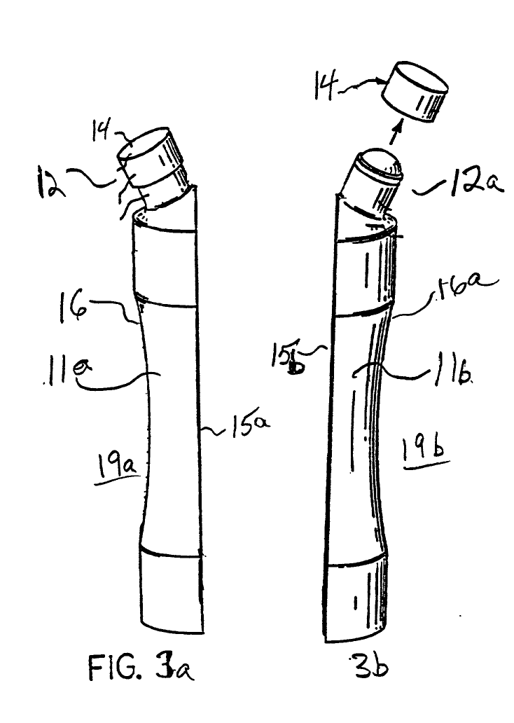

With reference to FIG. 14, there is depicted an illustrative embodiment of the present invention wherein two singlet applicator devices 19a and 19b (FIGS. 3a and 3b) are joined to form a doublet 20 (FIGS. 1 and 2). The singlet devices comprise an elongated hollow body portion 11a and 11b, containing a liquid reservoir, and a head portion 12 and 12a, containing a liquid dispenser (dauber 21) that may be covered by a cap 14 or 14a. The hollow body portions 11a and 11b comprise a flat side 15a and 15b and a rounded side 16 and 16a. The two singlets, are configured so that they may be joined conformably along mating sides 15a and 15b to form a doublet 20 as shown in FIG. 1. The two singlets may be joined along their conformable mating sides, such as flat sides, 15a and 15b, by various means, as described hereinabove, by gluing, cementing, sonic welding, or other means, to form the doublet applicator of the present invention. Preferably, the two singlets are joined with their liquid dispensers positioned at the same end of their elongated bodies with the dispeners oriented in opposing directions, as depicted in the accompanying drawings. However, if desired, the singlets may be oriented in such a manner as to position the applicators at opposite ends of the assembled doublet.

In a preferred embodiment, as shown in FIGS. 1 and 2 the singlets are held together by aligning their mating sides and wrapping a shrink-wrap plastic film 18 around the matched pair and heat sealing the film in a known manner, with or without the additional use of cement 17 or other joining means.

Within hollow body portions 11a-b are liquid reservoirs 22 and 23 for containing liquid, such as ink. Reservoirs 22 and 23 holding liquids 24 and 25, respectively, are in fluid communication with dauber 21 for controllably releasing ink or other selected liquid from reservoirs 22 or 23 when pressed against a surface. Daubers 21 are conventional and may be constructed using sponge rubber, open celled plastic foam, felt, or other material capable of absorbing a liquid and controllably releasing the fluid when the device is tipped and the applicator pressed against a surface. Preferably, the daubers are easily removable so that the liquid reservoirs may be refilled as needed through the head portion 12a or 12b. For ease of removing and replacing manually, it is convenient for the applicators to be constructed in a generally conical shape. Such construction is conventional and is shown in the literature, for example in U.S. Pat. No. 5,899,619, the disclosure of which is hereby incorporated by reference. The applicators may be used with a check-valve (not shown) to aid in controlling the release of liquid. Check-valves for such purpose are known and commercially available. Furthermore, by replacement of the liquid dauber 21 with a suitably perforated shaker head, the doublet device and method of construction, in accordance with the present invention, may be adapted to dispense powdered or granulated materials, for example, to provide a salt and pepper shaker, dispenser for spices, flavorants, or the like. Moreover, the design of the applicator of the present invention may be adapted to provide a bumper of the type set forth in U.S. Pat. No. 5,899,619, by incorporating a bumper of the type shown in that patent, near the dauber at the top end of one of the singlets, so that it will be approximately centered when two singets are joined to form a doublet.

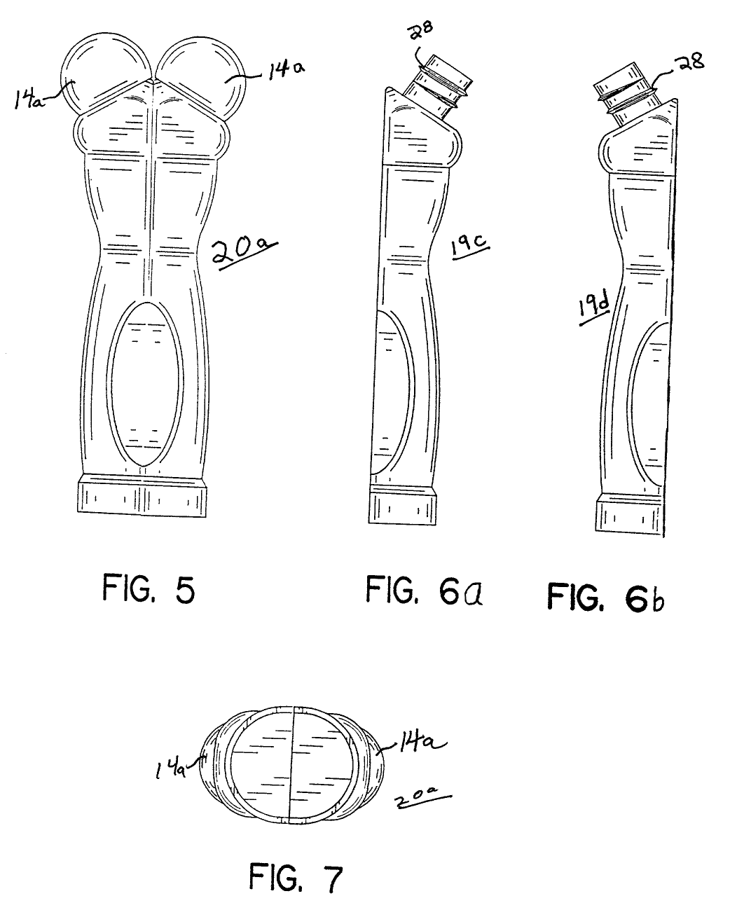

The doublet applicators of the invention may incorporate an ergonomic design, for example, as shown in FIGS. 5-7, for better holding by the user. FIGS. 6a and 6b show an embodiment of the singlets 19c and 19d that may be joined in accordance with the method of the present invention to form the doublet 20a depicted in FIGS. 5 and 7.

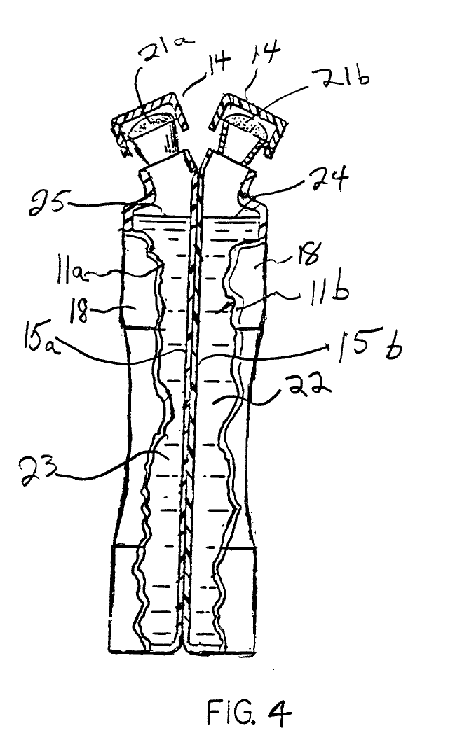

When the applicator device is not in use, the dispensers may be covered by caps 14 or 14a. Caps 14 or 14a may be placed over the dispensers 21 and secured by conventional fastening means such as a snap fit (FIGS. 1-4) or a threadable engagement (threads 28; FIGS. 6a and 6b) or other such means. The cap may be varied for esthetic reasons or to better accommodate the particular materials to be dispensed. Thus, for example, if a doublet device is to be used to dispense ketchup and mustard, the dauber may be omitted and it may be preferable to employ a hinged flip top cap.

Although the invention has been described with reference to certain embodiments thereof, it will be appreciated by those skilled in the art that modifications and variations may be made without departing from the spirit and scope of the invention as defined in the claims set forth below.

What is claimed is:

1. A doublet applicator device for applying either of at least two liquids to a surface, said doublet applicator device comprising two singlet applicator devices held together in a side by side relationship along mating sidewall portions thereof, each singlet applicator device comprising a housing having a top end, a bottom end and an elongated surrounding sidewall including a mating sidewall portion, said housing enclosing a liquid reservoir in fluid communication with a liquid dispenser at said top end.

2. A doublet applicator device according to claim 1 wherein each of said mating sidewalls is flat.

3. A doublet applicator device according to claim 2 wherein said singlet liquid applicator devices are held together by an outer shrink-wrap plastic film.

4. A doublet applicator device according to claim 2 wherein said singlet liquid applicator devices are held together by cement along said mating sidewalls.

5. A doublet applicator device according to claim 3 wherein each liquid applicator includes a removable cap.

6. A doublet applicator device according to claim 3 wherein said liquid dispenser is a dauber in fluid communication with said liquid reservoir wherein said dauber controllably releases a portion of said liquid onto a surface when said doublet applicator device is manipulated to press said dauber against said surface.

7. A method of manufacturing a doublet liquid applicator device having two refillable liquid reservoirs, each in fluid communication with a different liquid dispenser, said method comprising manufacturing a first and second singlet liquid applicator devices, each comprising a single refillable liquid reservoir in fluid communication with a dispenser, said first singlet liquid applicator device having an elongated sidewall surface that matches a surface on said second singlet liquid applicator device, aligning said singlet liquid applicator devices along matching surfaces and joining them together with an outer wrapping of shrink-wrap film to form said doublet liquid applicator device.
